(19) United States
(12) Patent Application Publication
(10) Pub. No.: US 2025/0170562 A1
(43) Pub. Date: May 29, 2025

(54) PROCESS FOR THE PREPARATION OF A CERIA-BASED CATALYST USEFUL IN SYNGAS PRODUCTION

(71) Applicant: CO2CO S.R.L., Bussi sul Tirino PE (IT)

(72) Inventors: Arturo DE RISI, Lecce LE (IT); Marco MILANESE, Arnesano LE (IT)

(73) Assignee: CO2CO S.R.L., Bussi sul Tirino PE (IT)

(21) Appl. No.: 18/713,973

(22) PCT Filed: Nov. 29, 2022
(86) PCT No.: PCT/IB2022/061532

§ 371 Date: May 28, 2024

(30) Foreign Application Priority Data
Nov. 29, 2021 (IT) 102021000030047

(51) Int. Cl. B01J 23/83; B01J 35/45; B01J 35/63; B01J 35/64; B01J 37/00; B01J 37/03; B01J 37/04; B01J 37/06; B01J 37/08; C01B 3/06

(52) U.S. Cl. CPC B01J 23/83; B01J 35/45; B01J 35/633; B01J 35/647; B01J 37/009; B01J 37/031; B01J 37/04; B01J 37/06; B01J 37/08; C01B 3/063

(57) ABSTRACT

The present invention relates to a process for the preparation of a cerium oxide catalyst doped with a metal having a reduced catalytic reduction temperature and a large reactive catalytic surface, making it particularly useful as a catalyst in the syngas production process from water and CO₂ as well as in the steel industry, as it allows CO₂ from the directly reduced iron production process (or DRI) to be converted into CO, the latter to be reused in the same process. The dopant metal is selected from copper, manganese and nickel.

### FIELD OF THE INVENTION

The present invention relates to the field of catalysts, and more particularly to a process for preparing a catalyst useful in the production of syngas (or synthesis gas), to the catalyst thus obtained and to its use.

### STATE OF THE ART

Syngas is a gas mixture consisting essentially of hydrogen and carbon monoxide, and is considered one of the most important intermediates in the production of a wide range of high-value industrial molecules, such as methanol, ethylene and propylene, and in energy production. The hydrogen contained in syngas is also a ‘clean’ fuel source from which energy can be produced without polluting emissions.

To date, syngas is mainly produced by reforming methane or by partial oxidation of fossil fuels, but other processes have also been developed to produce it from CO₂ and water by supplying thermal energy. Among these processes, two-phase thermochemical processes, based on the use of metal oxides, are a viable option for producing syngas and consist of a first phase (1) of endothermic reduction of metal oxide (MOox) to metal, or to metal oxide with a lower valence than the MOred metal;

MOₒₓ→MO_{red}+½O₂ (1)
and a second phase (2) which is the exothermic oxidation of the reduced metal oxide with water:

MO_{red}+H₂O→MOₒₓ+H₂ (2)
or a second phase (2′) in which the metal oxide is reduced with CO₂:

MO_{red}+CO₂→MOₒₓ+CO (2′)

The re-oxidised metal oxide can then be recycled back to the first phase. The overall reaction of the two-stage process illustrated above can be written as the following reaction (3):

H₂O→H₂+½O₂ (3)
or alternatively the following reaction (4):

CO₂→CO+½O₂ (4)

To improve the thermochemical processes described above, maximising syngas production, various metal oxides, such as ferrites, zinc oxide, cerium oxide, etc., have been studied and tested. Among these, processes using ferrites have slow kinetics and suffer from the sintering process, just as processes using zinc oxide which require a rapid hardening process due to the volatility of the material. Cerium oxide (CeO₂), instead, has performed well in the thermochemical production of CO by CO₂ dissociation. In fact, it is an active material with a high melting temperature of around 2800 K and high catalytic activity towards carbon-containing gases; moreover, it retains its properties, even after several thermal processes.

In one of the first works using cerium oxide to achieve H₂O splitting by means of a solar reactor, a considerable reduction of pure cerium oxide was achieved at 2000 K, accompanied by a partial vaporisation of the powders. The high operating temperature also led to other negative consequences, such as practical problems in reactor design and sintering phenomena that lowered the reactive surface of the metal catalyst (Furler P. et al., Energy Environ. Sci. (2012) 5, 6098-6103).

In order to lower the temperature required for the reduction reaction, various researches have therefore been carried out in recent years, leading to the development of doped catalysts. For example, Kaneko H. et al. in Energy (2007) 32:5, 656-663, proposed solid solutions containing cerium oxide and various transition metal oxides such as Mn, Fe, Ni and Cu as catalysts for the production of H₂ at 1273 K (approximately 1000° C.) in a tubular quartz reactor heated by an infrared furnace. The H₂ produced by the CeO₂-MOx catalysts was reported to be in greater quantities than that produced with pure cerium oxide, except in the case of doping with Cu, where the quantities of H₂ obtained were almost equal.

Again with copper as dopant, an even worse result was obtained by Abanades S. et al. J. Mater Sci. (2010) 45, 4163-4173, who synthesised CeO₂—CuO samples via a polymeric route derived from Pechini's method, and reduced them to a temperature of 1500° C. In this case, X-ray diffraction (XRD) analysis showed the coexistence of CeO₂ and Cu₂O, which was responsible for the mass losses of CuO during thermogravimetric analysis (TGA), while production data showed that these reduced Cu-based powders were not reactive with water to generate H₂ at a temperature of 1000° C.

Although other studies (see e.g. Le Gal et al. Energy Fuels (2011) 25, 4836-4845) have shown that cerium oxide powders synthesised with the Pechini method have a better catalytic capacity in H₂ production than the same powders obtained with different synthesis techniques, the results obtained with Cu doping have not been encouraging so far, as seen above.

The high reduction and conversion temperatures, highlighted in the aforementioned literature, are a major impediment to the dissemination of H₂O and CO₂ splitting technology to obtain syngas, due to the practical problem in designing a reactor suitable for such temperatures and the phenomena of structural modification (sintering, etc.) of the catalysts when exposed to temperatures above 1000° C. In the case of cerium oxide, which has been proposed as a catalyst for syngas production in several studies to date, the reduction temperature is 1673 K (approximately 1400° C.). In addition to the aforementioned problems of the reactor and sintering phenomena, a low thermal-to-fuel energy conversion efficiency (less than 3.5%), defined as the ratio between the calorific value of the syngas produced and the corresponding energy input required to produce it, has also been noted.

Commercially available cerium oxide catalysts have a further disadvantage; since they are designed to maximise the catalytic surface area, they are marketed in the form of extremely small particles (tens of nanometres) or, with a view to cost containment, immobilised on inert substrates such as ceramics. Catalysts in the form of particles of this size or immobilised on inert substrates are not suitable for use in fluidised bed reactors. Indeed, in order to fluidise the bed, the particles must be at least 20 microns in size (see Geldart diagram). When using commercially available catalysts in the form of smaller particle sizes, it has been noted that preferential paths are created, resulting in insufficient movement of the fluidised bed and poor reactor efficiency. One solution could be to encase the catalyst particles in larger particles, but this is excessively time-consuming and costly and has a negative impact on the efficiency of the catalyst.

At present, therefore, there is still a strong need for a suitably doped catalyst that, inserted into an appropriate reactor, overcomes the disadvantages described above for known catalytic systems, reducing process temperatures and also increasing conversion efficiency in the production of syngas from water and CO₂.

### SUMMARY OF THE INVENTION

The Applicant has now devised a process for preparing a cerium oxide catalyst doped with copper, manganese or nickel, having a reduced catalytic reduction temperature in a syngas production process from water and CO₂, and a reactive catalytic surface area increased by about six orders of magnitude over cerium oxide catalysts of the known art.

It is therefore an object of the present invention to provide a process for preparing an M/CeO₂ catalyst in which M is a dopant metal selected from the group consisting of copper, manganese and nickel, in the form of nano- and microparticles, the essential characteristics of which are defined in the first of the appended claims.

The catalyst obtainable by the aforementioned process, in particular in the form of a porous macrostructure, the reactor comprising this catalyst, and their use in the production of syngas from water and CO₂, the essential characteristics of which are defined in the respective independent claims, constitute further objects of this invention.

Furthermore, the catalyst according to any of the embodiments described herein is also found to be suitable in the iron and steel industry for the production of directly reduced iron (or DRI), in particular as a reducing agent in the conversion from CO₂, to CO, allowing for the reduction of climate-changing emissions in a hard-to-abate sector.

Further important features of the preparation process, the obtainable catalyst, the reactor comprising it, and the related use of this invention are defined in the dependent claims appended hereto.

### BRIEF DESCRIPTION OF FIGURES

The characteristics and advantages of the preparation process, of the catalyst, of the reactor comprising it and of their uses according to the invention, will result more clearly from the following description of their embodiments made by way of example and not by way of limitation with reference to the annexed drawings in which:

FIG. 1 schematically shows a longitudinal sectional view of an embodiment of the reactor (fixed bed) of the invention, useful for the conversion of water and CO₂ into syngas by means of a reaction catalysed by the catalyst of the invention;

FIG. 2 schematically shows a linear parabolic concentration system of solar radiation, usable for the energy supply of the reaction for conversion of water and CO₂ into syngas in the reactor of FIG. 1; a cross-section of the tube containing the catalyst of this invention is visible in the centre of the figure as a receiver element of the energy transmitted by the system.

FIG. 3 schematically shows a longitudinal cross-sectional view of a fluidised bed reactor useful for the conversion of water and CO₂ into syngas by means of a reaction catalysed by the catalyst of the invention.

FIG. 4 schematically shows a longitudinal sectional view of a double fluidised bed reactor, useful for the conversion of water and CO₂ into syngas by means of a reaction catalysed by the catalyst of the invention.

FIG. 5 schematically shows a possible application of the catalyst of the present invention in the steel industry. In particular, the figure shows how the catalyst can be used as a reducing agent to convert CO₂ deriving from the DRI (Direct Reduced Iron) process into CO, to be reused in the same process.

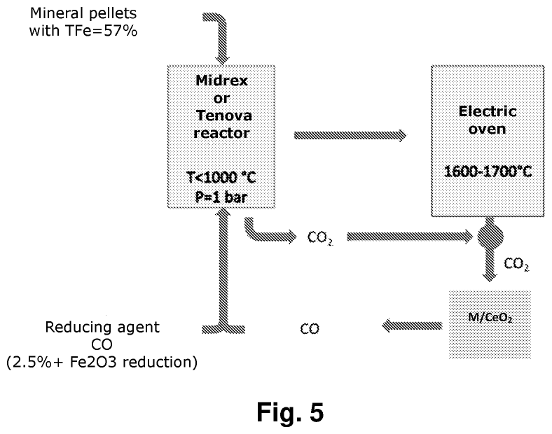

### DETAILED DESCRIPTION OF THE INVENTION

As mentioned above, the inventors have devised a process for the preparation of an M/CeO₂ catalyst in which M is a metal selected from the group consisting of copper, manganese and nickel, and preferably is copper, in the form of a porous macrostructure, comprising the following steps:
(i) providing an aqueous solution of salts of the metal M and cerium, in particular M(NO₃)₂ 3H₂O and Ce(NO₃)₃ 6H₂O, in a molar ratio M/(M+Ce) between 0.1 and 0.3;
(ii) providing an aqueous solution of cetyltrimethylammonium bromide (CTAB);
(iii) adding the aqueous solution of said salts of metal M and cerium to said solution of CTAB in a molar ratio of about 1:1 between CTAB and metal and cerium ions, and mixing;
(iv) adjusting to pH≥11 with an aqueous ammonia solution the pH of the solution obtained in step (iii) with formation of a precipitate in a mother liquor;
(v) calcining the precipitate at a temperature≥850° C.

In the context of the present invention, water preferably means deionised water.

In one aspect of the present process, the mixing in step iii) is carried out under vigorous agitation, for example for a time between 20 and 40 minutes.

In step iv) of this process, in which a precipitate is formed in a mother liquid, the liquid is preferably kept under stirring, for example for about 3 hours, at a temperature between about 70° C. and about 90° C., before the precipitate is separated from the mother liquid, for example by filtration. Precipitation in this step (iv) is caused by raising the pH of the solution to at least 11 (resulting in a zeta potential value of less than-40 mV) with an aqueous ammonia solution, e.g. of a concentration between 26% and 32% v/v.

Controlling the pH at this stage is important in order to give the catalyst the desired morphological characteristics, i.e. a porous macrostructure. In fact, as will be evident from the examples, working at pHs other than 11-12 does not give the same result.

Without wishing to be bound to any theory, the inventors hypothesise that pH, by influencing the zeta potential (ζ) of the mother liquor, also affects the deposition of the precipitate and thus its final morphological characteristics. In fact, it has been noted that at a pH lower than 11 (resulting in a zeta potential value greater than −40 mV), a different compactness of the precipitate is obtained, which negatively affects the performance of the catalyst.

The sedimentation step under controlled pH conditions thus makes it possible to obtain a precipitate in which the nanoparticles, previously dispersed in the mother liquid, aggregate to the correct degree of compactness to give aggregates of particles (or clusters) greater in size. A porous macrostructure, better defined below, is thus obtained, which is stabilised thanks to a subsequent drying phase.

Compared with catalysts known in the state of the art, therefore, it will not be necessary to immobilise the catalyst nanoparticles on an inert porous material because with the process of the invention, an equally porous structure is already obtained but entirely made up of catalyst.

The process of the invention thus makes it possible to obtain a catalyst with improved performance since the macroporous structure increases the catalytic surface that comes into contact with the gases.

Co-precipitation processes of the type of the present invention are traditionally considered disadvantageous in that they involve a grinding step of the precipitate downstream of the precipitation/dessication step in order to obtain nanoparticles. However, with the process according to any of the embodiments herewith disclosed which, as mentioned above, envisages a precipitation phase under controlled pH conditions, the precipitate after the drying and calcination phases is itself already effectively employable as a catalyst, precisely by virtue of the macroporous structure that can be obtained by controlling the deposition of the nanoparticles in the precipitation phase.

Therefore, the process of the invention does not provide for a micronisation or pulverisation phase of the dried precipitate, let alone a micronisation phase upstream of the precipitation, phases which would be necessary to prepare a catalyst in nanoparticle form such as those commercially available and described in the state of the art, and therefore to disaggregate the clusters of particles eventually formed with the precipitation. The process of the invention therefore does not comprise a micronisation or pulverisation step of the dried precipitate and/or a micronisation step upstream of the precipitation.

Instead, a coarse milling phase (up to a particle size greater than 20-30 microns) downstream of the drying phase may be envisaged so as to have macroporous structures of a size suitable to be fluidised in fluidised bed reactors. In any case, bed movement will result in a further reduction in catalyst particle size with a consequent increase in catalytic surface.

The precipitate can be washed with water and ethyl alcohol, then subjected to drying, e.g. by heating to about 110° C. for 9-12 hours.

According to a particular embodiment of the present process, the calcination step (v) is conducted by gradually increasing the temperature up to a value of 850° C., for example by initially increasing the temperature up to 500° C. at a rate of 1° C./min, maintaining this temperature for about 1 hour, then increasing to 850° C. at a rate of 3° C./min and maintaining this temperature for a further 3 hours.

In one aspect of the present process, the calcining temperature is between 850° C. and 1000° C.

Typically, the process of this invention was carried out entirely under ambient pressure.

In other words, the invention relates to a process for the preparation of an M/CeO₂ catalyst in the form of a porous macrostructure, in which M is a dopant metal chosen from the group consisting of copper, manganese and nickel, said process comprising the following steps:
(i) providing an aqueous solution of salts of the metal M and cerium, in particular M(NO₃)₂ 3H₂O and Ce(NO₃)₃ 6H₂O, in a molar ratio M/(M+Ce) between 0.1 and 0.3;
(ii) providing an aqueous solution of cetyltrimethylammonium bromide (CTAB);
(iii) adding the aqueous solution of said salts of metal M and cerium to said solution of CTAB in a molar ratio of about 1:1 between CTAB and metal and cerium ions (CTAB/(M+Ce)), and mixing;
(iv) adjusting the pH of the solution obtained in step (iii) to pH≥11 with an aqueous ammonia solution with formation of a precipitate in a mother liquor, separating the precipitate from the mother liquor and drying it by heating at 110° C. obtaining a porous macrostructure;
(v) calcining said porous macrostructure obtained in step iv) at a temperature≥ 850° C.

The above-described process, found by the inventors, enabled the preparation of a metal doped cerium oxide catalyst, also referred to herein as an M/CeO₂ catalyst, which exhibited improved properties compared to catalysts known in the art, particularly in terms of reactive catalytic surface, which was found to be increased by about 6 orders of magnitude, and in terms of catalytic reduction temperature in the process of producing syngas from water and CO₂, which was found to be reduced to 850° C.

Therefore, the present invention also relates to an M/CeO₂ catalyst obtained or obtainable by the process according to any of the embodiments described herein.

The catalyst of this invention has been characterised from a point of view of chemical composition, structure and morphology resulting in the following features:
homogeneous distribution of dopant M throughout the structure;
atomic % of dopant M between 20 and 22%;
atomic % of Ce between 78 and 80%;
specific surface area, defined as total surface area of the catalyst per unit mass, between 3 and 4 m²/g as measured by Brunauer-Emmett-Teller (BET) analysis.

Furthermore, this catalyst was found to be a porous macrostructure, with pores between 3.6 and 3.8 nm in diameter as measured by TEM electron microscopy and an average volume between 0.009 and 0.013 cm³/g as measured by BET. XRD analysis shows that this porous macrostructure consists of nanostructured particles smaller than 20 nm in size and aggregated together in clusters (or precisely aggregates of particles) with an average diameter of between 20 and 30 μm.

In other words, the present invention also relates to a porous macrostructure comprising or consisting of an M/CeO₂ catalyst in which M is a dopant metal selected from the group consisting of copper, manganese and nickel, with atomic % of metal M between 20 and 22% and atomic % of Ce between 78 and 80%, said macrostructure being characterised by pores having a diameter between 3. 6 to 3.8 nm and an average volume between 0.009 and 0.013 cm³/g, as measured by BET analysis, and by a homogeneous distribution of said dopant metal M throughout the structure.

In the context of the present description, the terms “catalyst in the form of a porous macrostructure” and “porous macrostructure comprising or consisting of a catalyst” are therefore used interchangeably.

The M/CeO₂ catalyst in the form of a porous macrostructure of the invention has been found to be particularly suitable for use in both a fixed bed and a fluidised bed reactor.

In particular, a fixed-bed reactor typically comprises a cylinder, suitably heated, containing a bed of catalyst particles, which are passed through by a mixture of different gases reacting due to the action of the catalyst. For the reactor to function properly, the bed must be sufficiently porous to allow gases to pass through it with low pressure losses.

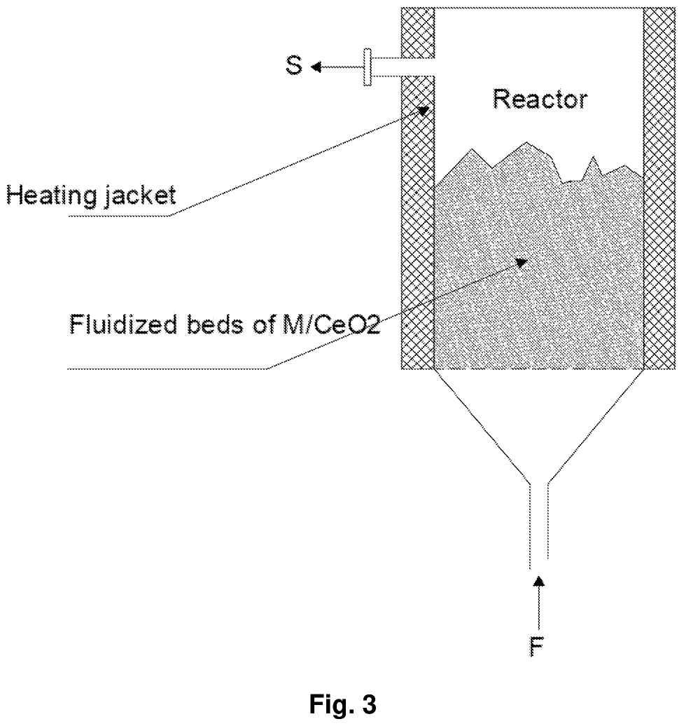

As is generally known in the art, in a fluidised bed reactor, a flow of gases passes through the solid bed, filling the inter-particle space. At a certain flow rate, the solid begins to expand and the upper surface of the bed assumes a moving profile. This ensures excellent mixing of the reactants with the catalyst. There is in fact contact between the gaseous molecules and the catalyst itself with a high reaction rate. An example of a fluidised bed reactor is shown schematically in FIG. 3.

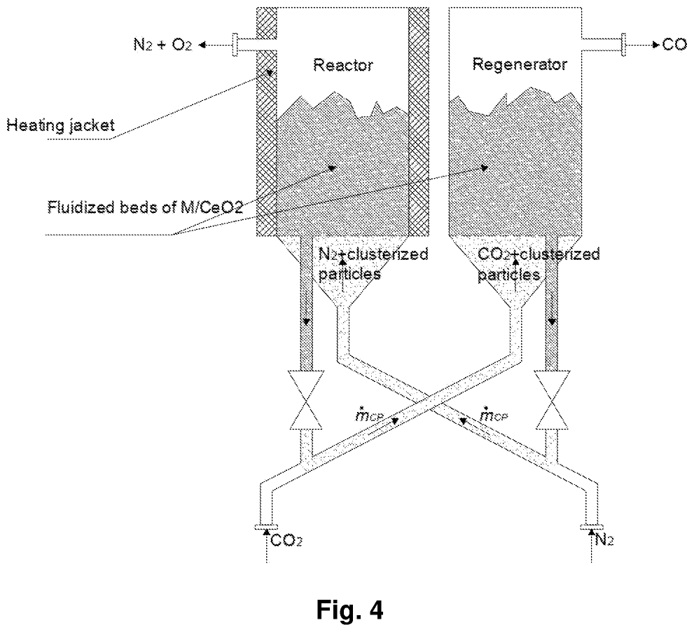

As is generally known in the art, dual fluidised bed reactors are used when the catalyst periodically requires a regeneration process. In this type of apparatus, the first fluidised bed serves as the actual reactor; in the second, catalyst regeneration takes place. An example of a fluidised bed reactor is shown schematically in FIG. 4.

The catalyst according to any of the embodiments of the present invention is found to be suitable for catalysing the syngas preparation process in each of these reactors. In particular, the conversion of CO₂ and water to syngas was achieved by fluxing the gases through a catalyst bed prepared according to the invention suitably heated to the correct reaction temperature.

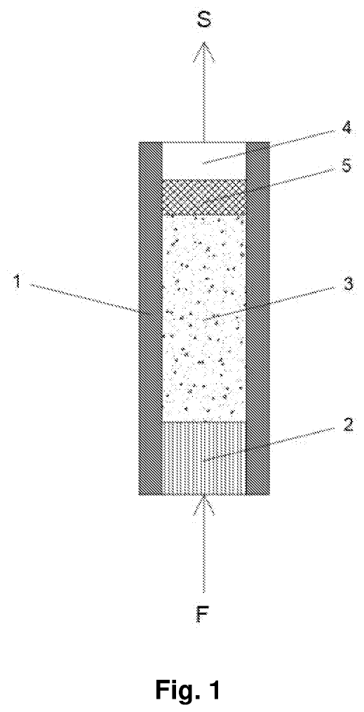

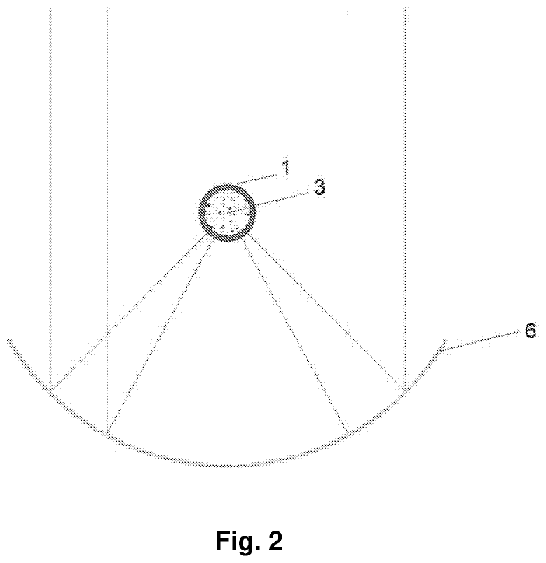

The inventors of this invention have also developed a reactor, an exemplary embodiment of which is illustrated in FIG. 1 attached hereto, suitable for containing the present catalyst and using it for the conversion of water and CO₂ into syngas. With reference to FIG. 2, the present reactor includes a heated tube 1 having an inlet provided with a flow distributor 2, configured to uniformly distributing throughout the section of the tube the gaseous flow F comprising mainly CO₂ and water vapour, as well as varying amounts of N₂, coming for example from a combustion plant, an oxyfuel plant or other source. The heated tube 1 further comprises a central zone 3 intended to house the catalyst so as to be invested and traversed by the incoming gaseous flow F, an outlet 4 and at least one filter 5 placed between the catalyst and the outlet 4 of the tube, so as to intercept and trap within it any catalyst particles carried by the gaseous flow towards the outlet of the tube. Advantageously, the outlet 4 of the tube is provided with a conduit for collecting the output syngas S formed and comprising mainly H₂ and CO, as well as varying amounts of N₂ and O₂.

In an aspect of this invention, the energy supply of the reactor is provided by a linear parabolic concentration system of solar radiation, which is capable of heating the reactor tube 1 and enabling the catalytic reaction for syngas production. One embodiment of such a system, illustrated in FIG. 2 attached hereto, comprises an optical body 6 for receiving solar radiation, which is a concentrating mirror capable of transmitting energy by heating to the reactor tube 1 of the mirror, located at the focal position of the mirror.

In addition to the aforementioned advantages related to the advantageous characteristics of the catalyst compared to catalysts known in the state of the art, this invention also has the advantage of being able to use the clean energy of solar radiation to power the catalysed syngas production reaction. This aspect, coupled with the possibility of using water and CO₂ from combustion plants as a starting material, makes the present invention particularly appreciable from the point of view of environmental sustainability.

As mentioned above, the catalyst of the invention can also be used in the iron and steel industry in particular in directly reduced iron or DRI processes, specifically to catalyse the conversion of CO₂ into CO, preferably where CO is then used in the same DRI process as the reducing agent instead of hydrogen. This makes it possible to significantly reduce the operating pressure of the Midrex or Teneva reactors commonly used and generally known to a person skilled in the art from 8 bar (according to the present technology based on using hydrogen as the reducing agent) to 1 bar (using CO as the reducing agent). Accordingly, the present invention also relates to the use of the porous macrostructure comprising catalyst according to any embodiment of the invention or the reactor according to any embodiment of the invention in the preparation of directly reduced iron (or DRI), preferably to catalyse the conversion from CO₂ to CO, more preferably wherein CO is then reused as a reducing agent in said DRI preparation process.

The following examples are given for illustrative and non-limiting purposes of the present invention.

### EXAMPLES

### Example 1: Preparation of Cu/CeO₂ Catalyst

Cu(NO₃)₂ 3H₂O and Ce(NO₃)₃ 6H₂O were dissolved in deionised water at molar ratios of Cu/(Cu+Ce) of 0.2. The resulting solution was added to a solution of CTAB in water in such an amount as to realise a 1:1 ratio of CTAB to Cu+Ce metal ions. The two solutions were mixed under vigorous stirring for 30 minutes, resulting in a single, clear and homogeneous solution. Subsequently, a 28% aqueous ammonia solution was added to this solution drop by drop and mixed under vigorous stirring until the pH reached a value of 11 (resulting in a zeta potential value of less than −40 mV) and a precipitate began to form in the mother liquor. After stirring the mother liquor for 3 hours at 80° C., the precipitate obtained was filtered and washed repeatedly with sufficient deionised water and ethyl alcohol. Finally, the recovered solid was dried at 110° C. for 12 hours in an electric oven and then underwent calcination in the same oven. Specifically, for calcination, the electric oven was programmed to reach 500° C. at a rate of 1° C./min, maintain this temperature for 1 hour, and then increase it to 850° C. at a rate of 3° C./min. The temperature of 850° C. was maintained for a further 3 hours. The entire process was carried out at ambient pressure.

### Example 2: Characterisation of the Porous Macrostructure

The catalyst, in the form of a porous macrostructure, was characterised by various analyses:
morphological analysis (performed using an SEM-Zeiss Germany scanning electron microscope)
X-ray diffractometry (chemical composition, lattice parameters and particle size of the porous macrostructure performed using Rigaku Ultima++)
BET (nitrogen adsorption isotherms were measured and the surface area was calculated using the Brunauer-Emmett-Teller (BET) method in the relative pressure range of 0.05 to 0.25; the analysis was performed using Quantachrome NOVA 2200);
BJH (Average pore size and pore volume were calculated using the Barrett-Joyner-Halenda method; analysis was performed using Quantachrome NOVA 2200).
X-ray fluorescence spectroscopy (analysis of dopant metal distribution homogeneity performed by Bruker M4 Tornado, Berlin, Germany).
particle size analysis with measurement of the D90 parameter of micrometric particles with a porous macrostructure (the analysis was carried out using the CILAS 1190 in wet mode).
measurement of the zeta potential during catalyst preparation (the measurement was performed using Z-Sizer-Malvern).

### Example 3 (comparative)—Effect of pH

The process of Example 1 was repeated with different pH values in the precipitation phase. It was noted that at pH values<11 and zeta potential>−40 mV, there was a degradation of the porosity of the porous macrostructure with a reduction in the average diameter of the clusters, making them unsuitable for use in fixed-bed or fluidised reactors.

The present invention has been so far described with reference to a preferred embodiment. It is to be understood that there may be other embodiments pertaining to the same inventive core, as defined by the scope of the claims reported below.

The invention claimed is:

1. A process for preparing an M/CeO₂ catalyst, wherein M is a dopant metal selected from the group consisting of copper, manganese and nickel, said process comprising the following steps:
i) providing an aqueous solution of M(NO₃)₂ 3H₂O and Ce(NO₃)₃ 6H₂O, in a molar ratio of M/(M+Ce) between 0.1 and 0.3;
ii) providing an aqueous solution of cetyltrimethylammonium bromide (CTAB);
iii) adding said aqueous solution of salts of metal M and cerium to said solution of CTAB in a molar ratio of approximately 1:1 between CTAB and metal and cerium ions, and mixing;
iv) adjusting the pH of the solution obtained in step iii) to pH≥11 with an aqueous ammonia solution, with the formation of a precipitate in a mother liquor, separate the precipitate from the mother liquor and dry it by heating to 110° C. thereby obtaining a porous macrostructure;
v) calcining said porous macrostructure obtained in step iv) at a temperature≥850° C.

2. The process according to claim 1, wherein said metal M is copper.

3. The process according to claim 1, wherein in said step iii) the mixing of the solutions is carried out under stirring for a time of between 20 and 40 minutes.

4. The process according to claim 1, wherein during said formation of a precipitate in step iv), said mother liquor is kept under agitation for 3 hours at a temperature of between 70° C. and 90° C.

5. The process according to claim 1, wherein the precipitate formed in step iv) is separated from the mother liquor by filtration, then washed with water and ethyl alcohol, and dried for 9-12 hours.

6. The process according to claim 1, wherein said calcining step v) is conducted by initially increasing the temperature at a rate of 1° C./min to 500° C., holding the temperature for 1 hour, subsequently further increasing the temperature to 850° C. at a rate of 3° C./min, and holding for a further 3 hours.

7. (canceled)

8. An M/CeO₂ catalyst in form of a porous macrostructure wherein M is a dopant metal selected from the group consisting of copper, manganese and nickel, with atomic % of metal M between 20 and 22% and atomic % of Ce between 78 and 80%, wherein said porous macrostructure consists of particles smaller than 20 nm in size and aggregated together in aggregates of particles with an average diameter of between 20 and 30 m, said macrostructure being by having pores with a diameter between 3.6 and 3.8 nm and an average volume between 0.009 and 0.013 cm³/g, as measured by BET analysis, and a homogeneous distribution of said dopant metal M throughout the structure.

9. The M/CeO₂ catalyst according to claim 8, wherein M is copper.

10. A reactor for converting water and CO₂ into syngas comprising as a catalyst the M/CeO₂ catalyst according to claim 8.

11. The reactor according to claim 10, comprising a heated tube and means for heating said tube comprising:
an inlet provided with a flow distributor suitable for distributing evenly throughout the section of said tube a gaseous flow (F) comprising CO₂ and water vapour;
a central zone configured for housing the catalyst so that said gaseous flow (F) passes through it;
an outlet for the syngas S formed;
and a filter placed between said central zone and said outlet to intercept and trap any catalyst particles carried by said syngas(S) towards the outlet.

12. The reactor according to claim 11, wherein said outlet of the heated tube is provided with a conduit for collecting the syngas(S) formed.

13. The reactor according to claim 10, further comprising a linear parabolic trough system of solar radiation as a heating means of said heated tube.

14. (canceled)

15. (canceled)
